(19) United States
(12) Patent Application Publication
(10) Pub. No.: US 2008/0089699 A1
(43) Pub. Date: Apr. 17, 2008

(54) METHODS FOR AUTOMATIC TUNING OPTICAL COMMUNICATION SYSTEM

(76) Inventors: Wen Li, Fremont, CA (US); Qing Zhu, San Jose, CA (US)

Correspondence Address: XIN WEN, 3449 RAMBOW DRIVE, PALO ALTO, CA, 94306, US

(21) Appl. No.: 11/550,385

(22) Filed: Oct. 17, 2006

(51) Int. Cl. H04B 10/04

(52) U.S. Cl. 398/197; 398/196

(57) ABSTRACT

A method for remotely tuning a transmitter in an optical communication system includes sending a control signal from a first location to a temperature controller at a second location and setting a first transmitter at the second location to a first temperature by the temperature controller in response to the control signal. The emission spectrum of the first transmitter can reach maximum power at or in the vicinity of a predetermined wavelength.

### BACKGROUND

The present disclosure relates to optical communication technologies.

Fiber to the premises (FTTP) is a desirable architecture for providing access from the user's premises. FTTP takes optical fibers all the way into the user's home or premises. Passive optical network (PON) is an attractive network design for the last-mile access because it does not require active components for directing optical signals between a central office and the network subscribers' terminal equipment. PON can include three main categories: time division multiplexing (TDM), wavelength division multiplexing (WDM), and a combination of TDM and WDM. Currently, time-division-multiplexing (TDM) PON is the primary deployment method for FTTP. TDM-PON is a point-to-multipoint architecture utilizing an optical power splitter at a remote mode. TDM-PON delivered downstream information through broadcasting and bandwidth sharing, and receives upstream information via time division multiple access (TDMA).

One drawback of the conventional WDM systems is the significant amount of wavelength specific inventory parts and time and labor required in tuning and the calibration of the optical components in the field. Technicians need to be dispatched to the field with wavelength specific parts and to tune and calibrate the transmitters at the installation and each recalibration. The users sometimes have to lose service for a long period of time while waiting for the field service of the technicians. Another drawback of the conventional WDM systems is that they are based on light sources emitting at fixed wavelengths or wavelength ranges. These light sources are expensive and difficult to maintain often with field dispatch of technician and service interruption. Furthermore, the calibration and tuning of the optical components in the conventional optical network systems are manual and often inaccurate. The cost of labor, time, and inventory related expenses are an obstacle for the application of the conventional optical network systems.

In a general aspect, the present specification relates to a method for remotely tuning a transmitter in an optical communication system. The method includes receiving a control signal at a first location from a second location and setting a first transmitter at the first location to a first temperature in response to the control signal. The emission spectrum of the first transmitter reaches maximum power at or in the vicinity of a predetermined wavelength.

In yet another general aspect, the present specification relates to a method for remotely tuning a transmitter in an optical communication system. The method includes receiving one or more control signals at a first location from a second location, setting a first transmitter at the first location to a first temperature in response to the one or more control signals, emitting a first optical signal by the first transmitter at the first temperature, measuring a first optical power of the first optical signal at the second location, setting the first transmitter to a second temperature in response to the one or more control signals, emitting a second optical signal by the first transmitter at the second temperature; measuring a second optical power of the second optical signal at the second location; and determining temperature dependence of the emission spectrum of the first transmitter in accordance with the first optical power, the second optical power, the first temperature, and the second temperature.

In yet another general aspect, the present specification relates to a method for initiating optical communication between an optical line terminal (OLT) and an optical network unit (ONU). The method includes selecting a first wavelength for optical communication between the OLT and the ONU, wherein the OLT comprise a first transmitter and the ONU comprises a second transmitter; sending a control signal from the OLT to a temperature controller in response to the control signal; and emitting an upstream optical signal by the second transmitter, wherein the spectrum of the upstream optical signal reaches a peak power at or in the vicinity of a predetermined wavelength.

In yet another general aspect, the present specification relates to a method for remotely tuning a transmitter in an optical communication system. The method includes setting a first transmitter at a first location to a first temperature; emitting a first optical signal by the first transmitter at the first temperature; measuring a first optical power of the first optical signal at a second location; setting the first transmitter to a second temperature; and determining temperature dependence of the emission spectrum of the first transmitter in accordance with the first optical power and the first temperature.

Implementations of the system may include one or more of the following. The emission spectrum of the first transmitter can have the maximum power at within 2 nanometer of the predetermined wavelength. The emission spectrum of the first transmitter can have the maximum power at within 0.2 nanometer of the predetermined wavelength. The first location can be an optical line terminal (OLT) or a central office, and the second location can be an optical network unit (ONU). The distance between the first location and the second location can be between 0.01 to 100 kilometers. The first transmitter can be selected from the group of a broad spectral light source, a multi-longitudinal mode (MLM) light source, a tunable laser, and thermally tuned DFB laser. The predetermined wavelength can be determined by an emission spectrum of a second transmitter at the first location. The method can further include emitting an optical signal by the first transmitter at the first temperature and receiving the optical signal by a receiver at the first location.

Embodiments may include one or more of the following advantages. The disclosed optical communication system can overcome the drawbacks in the conventional systems by providing self-adaptive and automatic tuning capabilities in the optical communication system. The disclosed system can thus significantly reduce the inventory costs and time, labor, service down-time, and associated expenses in calibrating and tuning the optical network systems. The disclosed system can also improve the robustness and the accuracy of the optical communications by eliminating manual operations in the system calibrations.

The disclosed optical communication system includes transmitters that have built-in feature for automatic and self-adaptive tuning. The transmitters are compatible with a wide range of light sources that have externally controllable emission spectra. The external control parameters can include temperature, an electric field, a mechanical force, and so on. For example, the disclosed system is compatible with a thermally tuned light source.

The disclosed optical communication system can be built with passive devices between the service provider's central office and the user's premises, which significantly reduces complexity and maintenance comparing to some conventional systems that use active devices in the field. The use of passive devices in the fields also improves the system reliability of the optical communication system.

Although the specification has been particularly shown and described with reference to multiple embodiments, it will be understood by persons skilled in the relevant art that various changes to form and details can be made therein without departing from the spirit and scope of the specification.

### BRIEF DESCRIPTION OF THE DRAWINGS

FIG. 1 is a block diagram for an optical communication network including a point-to-point optical link over a WDM network.

FIG. 2A is a block diagram of an optical communication system using transmitters based on tunable light sources.

FIG. 2B is a detailed view of the wavelength filter in the optical line terminal in the optical communication system of FIG. 2A.

FIG. 2C is a detailed view of the wavelength filter in the remote node in the optical communication system of FIG. 2A.

FIG. 3A illustrates details of a thermally tunable transmitter.

FIG. 3B illustrates typical temperature dependence of a center emission wavelength of a thermally tunable light source.

FIGS. 4-6 illustrate different protocols for automatically establishing an optical link in the disclosed optical communication system.

FIG. 7 illustrates protocol for a maintenance procedure between two optical ports in the disclosed optical communication system.

### DETAILED DESCRIPTION

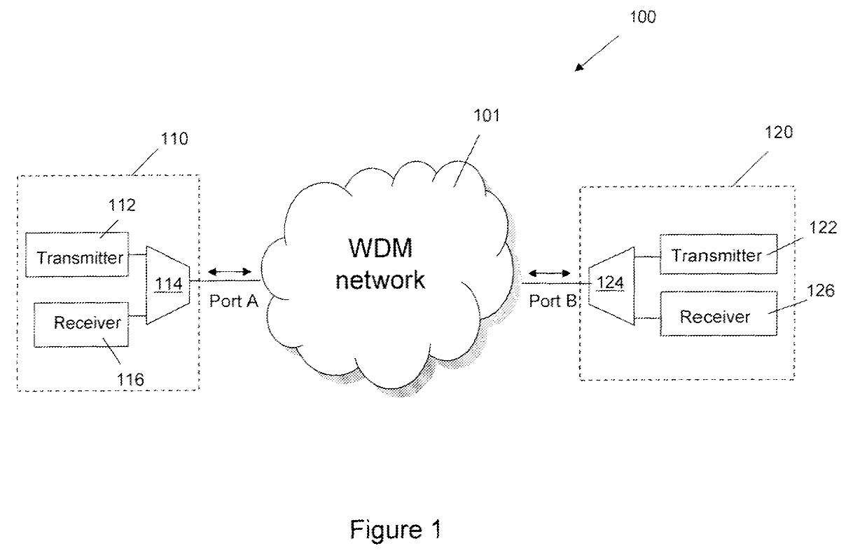

Referring to FIG. 1, an optical communication system 100 includes a WDM network 101 having a Port A and a Port B. A transceiver port 110 is connected to Port A. A transceiver port 120 is connected to Port B. The transceiver port 110 includes a transceiver 112, a receiver 116, and a separating/combining device 114 that is connected to the WDM network 101. The separating/combining device 114 can facilitate bi-directional optical transmissions on single fiber connection. Similarly, the transceiver port 120 includes a transceiver 122, a receiver 126, and a separating/combining device 124 that is connected to the WDM network 101.

In the present specification, the transceiver ports 110 and 120 can automatically establish optical link through a wavelength auto-alignment protocol. The transmitters 110 and 120 can be tunable light source such as tunable distributed-feedback (DFB) laser, multiple-longitudinal mode Fabry-Perot laser (MLM-FP), laser array, or broadband sources light-emitting diode (LED) or super-luminescent diode (SLD). In other words, the emission spectra of the transmitters 110 and 120 can be tuned using external signals such as controlling the temperature of the transmitters, mechanical control of the grating-angle, and electrical adjustment of the band-gap of the light emitting material in the transmitter, etc. Each transceiver port 110 or 120 is also capable of monitoring the received optical power and reports the power level through the WDM network 101. In contrast, the transmitters in the conventional WDM optical network systems are pre-adjusted to emission wavelengths each corresponding to a specific wavelength channel (see definition below). The transmitters having fixed emissions wavelength are the main reason for the high costs and complexity in the conventional optical network systems.

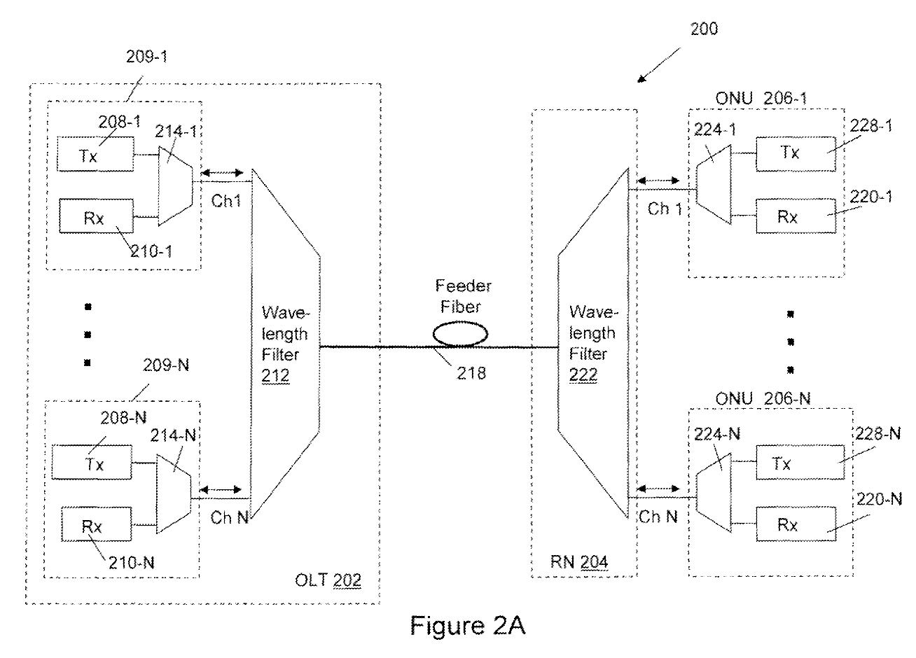

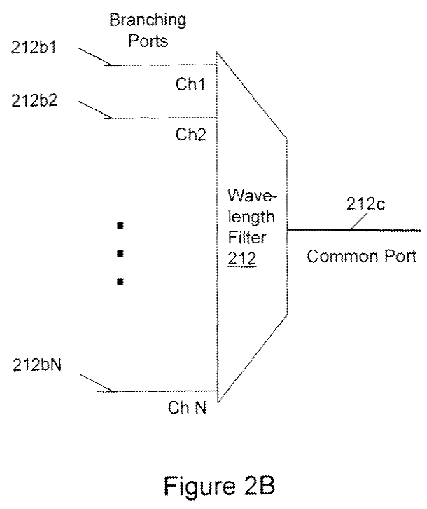

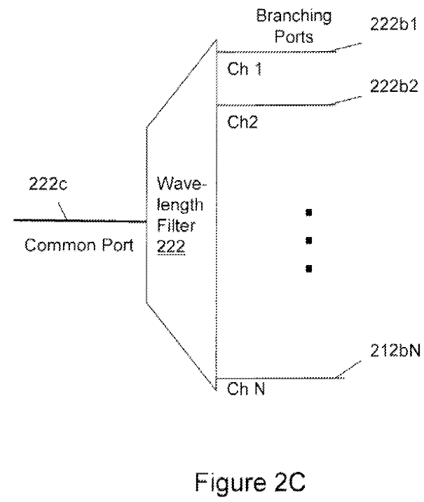

FIG. 2A shows an optical communication system 200 in accordance with an embodiment of the present specification. The optical communication system 200 includes an OLT 202, a remote node (RN) 204 in connection with the OLT 202 through an optical network, and a plurality of ONUs 206-1, 206-2 . . . 206N in connection with the RN 204. The typical distance between the OLT 202 and the ONU 206-1, 206-2 . . . 206N can be in the range of 0.01 to 100 kilometers.

The optical communication system 200 can include two wavelength filters: a wavelength filter 212 in the OLT 202 and a wavelength filter 222 at the RN 204. The wavelength filter 212 and the wavelength filter 222 are wavelength division multiplexing (WDM) filters that are symmetrically implemented in the OLT 202 and the RN 204. The wavelength filters 212 and 222 can be implemented by arrayed-waveguide gratings (AWG) that can be tuned to the common communication bands, including O, E, S, C, L or U-band and typically follow the wavelength grids of International Telecommunication Union (ITU). The wavelength filters 212 or 222 can also be based on other forms of WDM filters such as thin-film DWDM and CWDM filters.

The wavelength filter 212 and 222 can receive optical signals at separate branching ports (i.e. 212b1, 212b2 . . . 212bN and 222b1, 222b2 . . . 222bN as shown FIGS. 2A and 2C) and filter (or slice) the optical signals to output multiplexed signals at the common ports (i.e. 212c, and 222c in FIGS. 2B and 2C) of the wavelength filter 212 or 222. Each of the multiplexed signals carries data from the respective input optical signals. The output multiplexed signals are respectively located in a plurality of predetermined wavelength channels “Ch1”, “Ch2”. . . “Ch N” identical to both wavelength filters 212 and 222. The wavelength channels “Ch1”, “Ch2” . . . “Ch N” are determined by the pass bands of the wavelength filters 212 and 222, and characterized by unique channel numbers (or wavelength channel numbers, 1,2 . . . N) and specific center wavelengths (λ_{Ch1}, λ_{Ch2} . . . λ_{ChN}), the pass band width and the optical isolation between each wavelength channel. The adjacent channel spacing (|λ_{Chi}˜λ_{Chi-1}|, I=2, 3 . . . N) between the wavelength channels “Ch1”, “Ch2” . . . “Ch N” of the filters 212 or 222 can range from a few tens to a few thousands of gigahertz.

Referring to FIG. 2B, the wavelength filter 212 includes a plurality of branching ports 212b1, 212b2 . . . and 212bN, and a common port 212c. Each of the branching ports 212b1, 212b2 . . . or 212bN is associated with a distinct and specific wavelength channel “Ch1”, “Ch2” . . . or “Ch N”. The wavelength filter 212 can receive a downstream optical signal at a branching ports 212b1, 212b2 . . . or 212bN, and filter (or slice) the spectrum of the downstream optical signal. The wavelength filter 212 then outputs a downstream multiplexed signal at the common port 212c. The spectrum of the downstream multiplexed signal is located in the specific wavelength channel associated with the branching port 212b1, 212b2 . . . or 212bN at which the downstream optical signal is received. In other words, the spectrum of the downstream multiplexed signal at the common port 212c is determined by the wavelength channel associated with the branching port 212b1, 212b2 . . . or 212bN at which the input downstream optical signal is received.

The wavelength filter 212 can also process optical signals in the reverse direction. An upstream optical signal (received from the wavelength filter 222 via the feeder fiber 218) can be received at the common port 212c. The upstream optical signal is characterized by a spectrum in a specific wavelength channel “Ch1” or “Ch2” . . . “Ch N”. The wavelength filter 212 can route the upstream optical signal to one of the branching ports 212b1, 212b2 . . . or 212bN in accordance with the wavelength channel of the upstream optical signal. The routing is so arranged that the wavelength channel of the upstream optical signal matches the wavelength channel of the receiving branching port 212b1, 212b2 . . . or 212bN. The upstream optical signal routed to a branching port 212b1, 212b2 . . . or 212bN is subsequently transmitted to one of the transceiver ports 209-1, 209-2, or 209-N.

The optical communication system 200 further includes a plurality of transceiver ports 209-1, 209-2 . . . 209-N that can reside in the OLT 202. Each transceiver port 209-1, 209-2 . . . 209-N can include a transmitter 208-1 (or 208-2 . . . 208-N) for providing downstream optical signals and a receiver 210-1 (or 210-2 . . . 210-N) for receiving upstream optical signals. In one embodiment, the transceiver port 209-1, 209-2 . . . 209-N can be implemented as integrated optical transceiver modules, which can include temperature control and sensing capabilities for the transmitters 208-1 . . . 208-N. The integrated optical transceiver modules can also provide output signals that represent the power levels of the transmitters 208-1 . . . 208-N.

Each transceiver port 209-1, 209-2 . . . 209-N is connected with one of the branching ports 212b1, 212b2 . . . 212bN of the wavelength filter 212 and is thus associated with a specific wavelength channel “Ch1”, “Ch2” . . . “Ch N” of the wavelength filter 212. The wavelength filter 212 can be coupled with the transceiver ports 209-1, 209-2, . . . 209-N by single-mode optical fibers. The optical signals produced by the transmitters 208-1, 208-2 . . . 208-N are filtered by the wavelength filter 212 to produce multiplexed signals each occupying a wavelength channel specific to the respective branching port 212b1, 212b2 . . . or 212bN of filter 212. The receivers 210-1, 210-2 . . . 210-N are configured to receive signals having their wavelength channels specific to the respective branching ports 212b1, 212b2 . . . and 212bN of the wavelength filter 212.

The transmitters 208-1, 208-2 . . . 208-N can be based on thermally tunable light source transmitters that can be directly modulated to carry the downstream optical signals. The transmitters 208-1, 208-2 . . . 208-N also can be implemented by tunable lasers, thermally tuned Fabry Perot (FP) lasers, temperature controlled super luminescent diodes (SLD) and its variant.

Each transceiver port 209-1 . . . 209-N can include a signal separating/combining device 214-1 . . . 214-N to assist bi-directional communications in either downstream or upstream directions. These signal separating/combining devices 214-1 . . . 214-N can be implemented by WDM filters, power splitter, and circulators. The signal separating/combining devices 214-1 . . . 214-N can enable bi-directional transmission of optical signals with a single optical connection to the wavelength filter 212.

Referring to FIG. 2C, the wavelength filter 222 includes a plurality of branching ports 222b1, 222b2 . . . and 222bN, and a common port 222c. Each of the branching ports 222b1, 222b2 . . . and 222bN is associated with a distinct and specific wavelength channel “Ch1”, “Ch2” . . . or “Ch N”. Each branching port 222b1, 222b2 . . . or 222bN is respectively connected with an ONU 206-1 . . . 206-N. The wavelength filter 222 can receive an upstream optical signal at a branching ports 222b1, 222b2 . . . or 222bN from an ONU 206-1 . . . 206-N, and filter (or slice) the spectrum of the upstream optical signal. Each of the ONUs 206-1 . . . 206-N is specifically associated with a counterpart transceiver port 209-1 . . . 209-N in the OLT 202 and is characterized by a specific wavelength channel determined by the filter function of the filters 212 and 222. Each wavelength channel can carry bidirectional signals. The wavelength filter 222 then outputs an upstream multiplexed signal at the common port 222c (via feeder fiber 218). The spectrum of the upstream multiplexed signal is located in the specific wavelength channel associated with the branching port 222b1, 222b2 . . . or 222bN at which the upstream optical signal is received. In other words, the spectrum of the upstream multiplexed signal at the common port 222c is determined by the wavelength channel associated with the branching port 222b1, 222b2 . . . or 222bN at which the input upstream optical signal is received.

Each ONU 206-1 . . . 206-N can include a transmitter 228-1 (or 228-2, 228-N) for providing an upstream optical signals and a receiver 220-1 (or 220-2, 220-N) for receiving downstream optical signals. Each ONU 206-1, 206-2 . . . 206-N is connected with a branching port 222b1, 222b2 . . . 222bN of the wavelength filter 222 and is associated with a specific wavelength channel “Ch1”, “Ch2” . . . “Ch N” of the wavelength filter 222. The wavelength filter 222 can be coupled with the ONUs 206-1 . . . 206-N by single-mode optical fibers. The optical signals produced by the transmitters 228-1 . . . 228-N are filtered by the wavelength filter 222 to produce multiplexed upstream signals with specific wavelength channels determined by the branching ports 222b1, 222b2 . . . and 222bN of the wavelength filter 222.

The wavelength filter 222 can receive downstream optical signal via the feeder fiber 218 at the common port 222c. The downstream optical signal is characterized by a wavelength channel of one of the branching ports 212b1, 212b2 . . . and 212bN of the wavelength filter 212. The wavelength filter 222 can route the downstream optical signal to one of the branching ports 222b1, 222b2 . . . or 222bN in accordance with the wavelength channel of the downstream optical signal such that the wavelength channel of the downstream optical signal matches the wavelength channel of the receiving branching port 222b1, 222b2 . . . or 222bN. The downstream optical signal routed to a branching port 222b, 222b2 . . . or 222bN is subsequently transmitted to one of the ONUs 206-1 . . . 206-N.

The receivers 220-1 . . . 220-N in the ONUs 206-1 . . . 206-N are configured to receive downstream signals that are transmitted through the specific filter channel. As an example, the ONU 206-1 and the OLT 209-1 share the same wavelength channel—“Ch1”. The ONU 206-2 and the transceiver port 209-2 share the same wavelength channel “Ch2”, and so on. Each ONU 206-1 . . . 206-N includes a signal separating/combining device 224-1 (or 224-2 . . . 224-N), a transmitter 228-1 (or 228-2 . . . 228-N), and a receiver 220-1 (or 220-2 . . . 220-N). The transmitters 228-1 . . . 228-N can be tunable WDM light sources, which may have different implementations from the transmitter 208-1 . . . 208-N.

Although an ONUs 206-1 . . . 206-N and its counterpart transceiver port 209-1 . . . 209-N in the OLT 202 share the communication tasks in each channel “Ch1”, “Ch2” . . . or “ChN”, they do not have to operate in exactly the same wavelength range for both downstream and upstream transmission. For example, utilizing the cyclic features in the case of AWGs as the wavelength filters 212 and 222, the downstream and upstream signals can occupy different wavelengths, which are separated by a multiple of free spectral ranges (FSRs).

The transmitter 228-1 . . . 228-N can produce upstream optical signals to be sent to the common port 222c at the wavelength filter 222 wherein the upstream optical signals are sliced (or filtered) into specific wavelength channels. For example, the upstream optical signal from the ONU 206-1 is filtered by the wavelength filter 222 to produce an upstream signal in the wavelength channel “Ch 1” that is also specific to the transceiver port 209-1. The upstream signal can be amplified if necessary, passing through the wavelength filter 212 and the signal separating/combining device 214-1, and being received by the receiver 210-1 in the transceiver port 209-1.

In the downstream direction, the optical signal produced by the transmitter 208-1 passes the signal separating/combining device 214-1 and is sliced (or filtered) by the wavelength filter 212 into a downstream signal in the wavelength channel “Ch 1”. The downstream signal is next amplified if necessary and transmitted to the wavelength filter 222 at the RN 204. The wavelength filter 222 then routes the downstream signal in “Ch 1” to the ONU 206-1 that is characterized by the same wavelength channel “Ch 1”. As described, each of the ONUs communicates downstream or upstream in its specific wavelength channel within each system. The secure wavelength specific communications in the disclosed system is a significant improvement over the broadcasting mode of communications in some conventional systems.

Details about the optical network system 200 are disclosed in the pending U.S. patent application Ser. No. 11/396,973, titled “Fiber-to-the-premise optical communication system” by Li et al, filed Apr. 3, 2006, U.S. patent application Ser. No. 11/413,405, titled “High speed fiber-to-the-premise optical communication system” by Li et al, filed Apr. 28, 2006, and U.S. patent application Ser. No. 11/446,276, titled “Adaptive optical transceiver for fiber access communications” by Li et al, filed Jun. 2, 2006. The content of these disclosures is incorporated herein by reference.

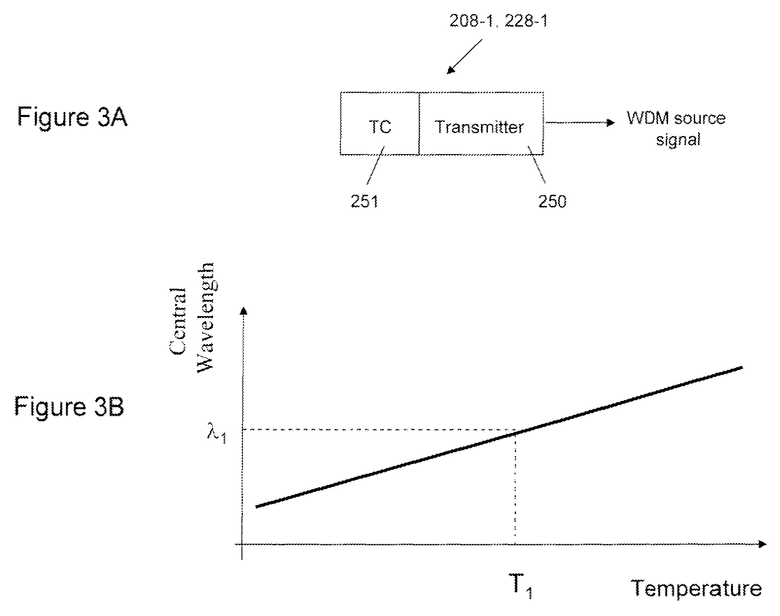

In some embodiments, the emission spectrum of the transmitter 208-1 . . . 208-N and 208-1 . . . 228-N can be tuned by varying temperature to cover part or all the wavelength channels of the wavelength filters 212 and 222. As shown in FIG. 3A, the transmitter 208-1 or 228-1 can include a thermally tunable transmitter 250 (WDM-TX) and a temperature controller 251. The transmitter 250 is in thermal contact with the temperature controller 251. The temperature controller 251 can be a thermal electric temperature controller integrated in the transmitter 208-1 or 228-1. An advantage of the use of tunable light sources in the optical communication system 200 is that the transmitter 208-1 . . . 208-N and the transmitter 228-1 . . . 228-N can be easily tuned and locked to a center wavelength in one of a large number of individual wavelength channels.

FIG. 3B illustrates the temperature dependence of the center wavelength of a typical tunable light source compatible with the disclosed systems 100 and 200. The temperature controllers 251 can be controlled to set the transmitter 250 to different temperature set-points such that the respective transmitters can provide stable optical signal for wavelength channels in different wavelength ranges. For example, a wavelength channel can be selected at a center wavelength λ₁. The transmitter 250 can emit maximum emission power at the center wavelength λ₁ when the transmitter 250 is controlled at temperature T₁. It should be noted that the thermal tuning of the center wavelength of an emission spectrum is applicable to different optical sources such as FP laser, DFB laser, LED and SLD sources.

In some embodiments, the thermally tunable light sources in the disclosed system can include broad envelope in their emission spectra. The thermally tunable light sources suitable for the transmitters 208-1 . . . 208-N and 228-1 . . . 228-N can accept wavelength accuracy>0.1 nanometer or even a few nanometers. The temperature controller 251 can thus be implemented by much simpler and less costly controller devices compared to the temperature controlling devices for the narrow-wavelength lasers in the conventional systems. In contrast, the fixed wavelength lasers in the conventional WDM optical network systems typically require a wavelength accuracy within 0.1 nanometer, which can be costly to implement and maintain.

The optical network systems 100 and 200 provide automatic wavelength tuning of the transmitters 112, 122, 208-1 . . . 208-N and 228-1 . . . 228-N. The center wavelength of the emission spectra for transmitters 112, 122, 208-1 . . . 208-N and 228-1 . . . 228-N can be controlled by setting the temperature to the transmitters. The emission spectra for transmitters 208-1 . . . 208-N and 228-1 . . . 228-N in conjunction with the temperature control can be sufficient to cover part or all the wavelength channels of the wavelength filters 212 and 222. The temperature and thus wavelength control of the transmitters 208-1 . . . 208-N at the OLT 202 or the transmitters 228-1 . . . 228-N at the ONUs 206-1 . . . 206-N can be carried out separately through the following procedures. The transmitters 208-1 . . . 208-N and 228-1 . . . 228-N can automatically adapt to their corresponding wavelength channels at initial system startup or during continuing operation. Transceiver ports 120 and 110 in the optical network system 100 can follow the similar procedures and automatically aligned at their corresponding wavelength channel (Port A and Port B).

The output power in the transmitters 208-1 . . . 208-N and 228-1 . . . 228-N can be monitored by photo detectors in the corresponding transceivers. The wavelength tuning and locking of the transmitters 208-1 . . . 208-N and 228-1 . . . 228-N can include one or more of the following tuning procedures.

1) The output power of a transmitter 208-1 . . . 208-N at OLT 202 is measured using external or internal feedback monitors while tuning the temperature of individual transmitters. The optimal temperature that corresponds to the highest output power can be stored for a transmitter 208-1 . . . 208-N. The temperature of the transmitter 208-1 . . . 208-N is locked to the optimal temperature as its initial coarse setting.

2) The transmitter 228-1 . . . 228-N at an ONU 206-1 . . . 206-N can be set into a passive (slave) state by the commands from OLT 202. Transmission power from the ONU 206-1 . . . 206-N can be measured at corresponding receiver 210-1 . . . 210-N the OLT 202 while tuning the temperature of the remote transmitter 228-1 . . . 228-N. The optimal temperature of the transmitter 228-1 . . . 228-N is determined by the maximum power of the transmitter 228-1 . . . 228-N measured at corresponding receiver 210-1 . . . 210-N at the OLT 202. The transmitter 228-1 . . . 228-N can then be set and lock at the optimal temperature.

3) Each transmitter 208-1 . . . 208-N at the OLT 202 or the corresponding transmitter 228-1 . . . 228-N at an ONU 206-1 . . . 206-N can be set to an interactive mode for fine tuning of the center wavelength through interactive power feedbacks between the corresponding transceiver port 209-1 . . . 209-N and the ONU 206-1 . . . 206-N. For example, to fine tune the transmitter 208-1 . . . 208-N at the OLT 202, the temperature of a transmitter 208-1 . . . 208-N is tuned near its coarse optimal temperature obtained as described above. The transmitter 208-1 . . . 208-N is controlled to emit an optical signal. The power of the optical signal are measured by the receiver at the corresponding ONU and reported back to OLT. The system at OLT can then select the peak power for the optimal temperature. To fine tune the ONU, each transmitters 228-1 . . . 228-N at ONU tunes near its coarse optimal temperature obtained as described above. The receiver at the corresponding OLT nodes measures the upstream optical signal from the transmitter at the ONU. The temperature that corresponds to the maximum power output is selected. The optimal temperature can then be stored at the ONU and locked in the local ONU controller.

In cases that optical power monitor is not provided as output signal in the transceivers, a digital SD (Signal Detect) signal can be available as an internal feedback within the transceiver during normal operation. In this case, the emission spectral tuning and locking of the transmitter can include any one or all of the following automatic approaches.

1) The wavelength-temperature coefficient of a transmitter can be measured using external monitors while tuning the temperature of the transmitters. This pre-calibrated data then can be stored at the OLT 202. Usually, the temperature coefficients of a same type of tunable light source have good uniformity among different units. Thus, the appropriate temperatures of transmitter 208-1 . . . 208-N at OLT 202 can be pre-set and locked by the respective temperature controllers.

2) Each transmitter 228-1 . . . 228-N at the ONUs 206-1 . . . 206-N can receive commands from the OLT 202 after the downstream links are established. The command can include the wavelength of the transceiver ports 209-1 . . . 209-N s corresponding to the ONUs 206-1 . . . 206-N. Similarly, from the pre-calibrated data of temperature coefficient, the optimal temperature can be calculated and locked by the temperature controller at each ONU 206-1 . . . 206-N.

3) If the calibration data are unavailable, an in-service calibration process can automatically tune and lock the temperatures of tunable light sources. For example, if the temperature coefficient of the transmitter 228-1 is unknown, it can scan temperature from low to high while sending out the real-time temperature information and optical signals at different temperatures. Once spectrum 228-1 shifts into and encompasses the corresponding wavelength channel “Ch 1”, the upstream link will be established and receiver 210-1 at OLT 202 will be able to record the current temperature of transmitter 228-1 at T1. When temperature of 228-1 keeps going up and finally at a point that the spectrum of the tunable light source 228-1 moves out of the wavelength channel, the upstream link then will be disconnected. The receiver 210-1 at OLT 202 will be able to record the current temperature at T2. Then the optimal temperature for the transmitter 228-1 is the center point of T1 and T2. The information of the optimal temperature can be sent to ONU through the downstream link.

4) The automatic tuning methods described in 3) can be utilized to identify and lock the temperatures of the transmitters at OLT, and also can be utilized simultaneously to set the temperatures of a pair of transmitters at OLT and ONU.

It is important to note that although the above described transmitter tuning procedures in the disclosed optical network systems 100 and 200 are not limited to the thermally tuned light sources. The same procedures for tuning, locking, and refining the center wavelength of emission spectrum is also applicable to other types of tunable light sources.

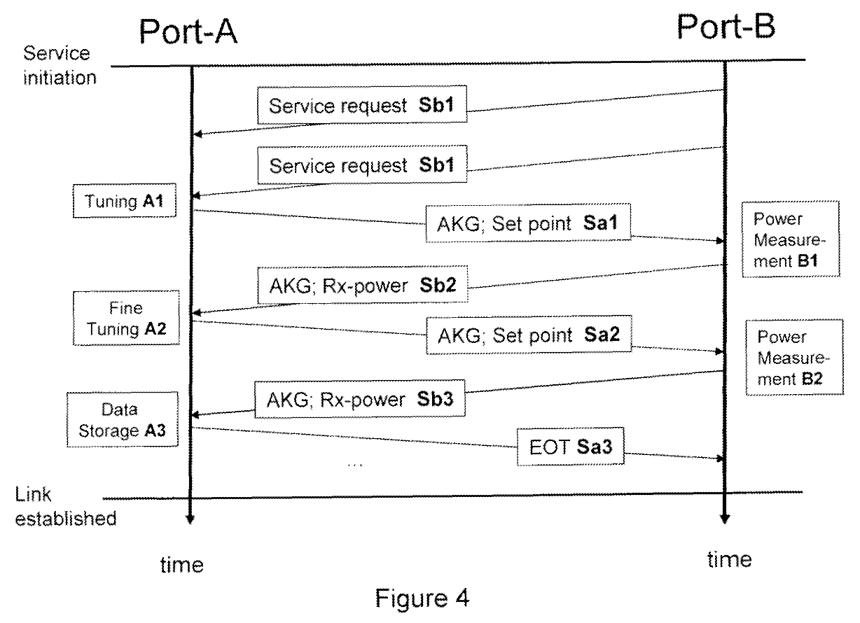

FIG. 4 illustrates a procedure for initiating optical link between Port A and Port B in the optical network systems 100. The transmitter 122 is previously tuned to a specific wavelength channel having a central wavelength at Port B. The transmitter 122 in Port B can include manually aligned DFB laser, broadband source, an MLM light source, or other types of WDM sources. A service initiation is requested by Port B. The optical-link initiation procedure can include one or more the following steps:

1) Port B sends one or more messages Sb1 to Port A. The messages can include service request and other initiation information.

2) Once Port A receives Sb1, Port A starts a self-tuning process A1 for the transmitter 112. The self-tuning process A1 varies the maximum emission of the transmitter 112 by scanning the temperature of the transmitter 112 until the maximum emission peak is substantially the same as the wavelength channel having the center wavelength at Port A.

3) After the self-tuning process A1 is completed, the transmitter 112 at Port A sends out message Sa1 that can contain acknowledgement of receipt (AKG) of Sb1 to Port B. Port A also sends the set-point is the current wavelength setting of the transmitter 112.

4) Once the message Sa1 is received by Port B, it starts a procedure B1 to measure power of the optical signal from the Port A. Then Port B sends a message Sb2 to Port A, which can contain AKG of the message Sa1 and a result of the power measurement (Rx-power) that indicates the accuracy of a wavelength alignment of transmitter 112 at current wavelength setting.

3) Upon reception of the message Sb2, Port A starts a fine tuning procedure A2. The fine tuning procedure A2 can include setting the maximum emission peak of the transmitter 112 to accurately match the wavelength channel at Port A. After the tuning, Port A returns a message Sa2 that can include AKG of Sb2 and an updated temperature set point for the transmitter 112. Port B starts power measurement B2 once it receives the message Sa2. Port B then returns to Port A a message Sb3 that can include AKG for Sa2 and the result of the power measurement B2.

6) Upon the receipt of Sb3. Port A starts a process A3 that can that can calculate the best wavelength setting for the transmitter 112, adjust the wavelength setting accordingly, and store the wavelength setting data.

7) Port A can end the optical-link initiation procedure by sending a message Sa3 that contains an End of Tuning (EOT) message.

In some embodiments, the optical-link initiation does not need fine tuning. The optical-link initiation process can end after the step 3. In some other embodiments, the fine tuning steps in steps 4 and 5 may be repeated in order to achieve the best wavelength alignment.

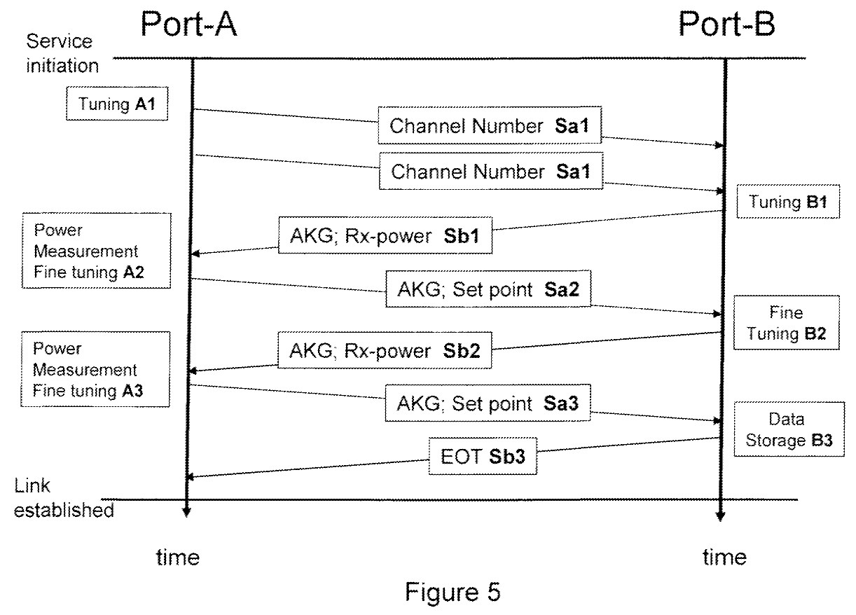

FIG. 5 illustrates another procedure for initiating optical link between Port A and Port B in the optical network systems 100, in which both Port A and Port B require wavelength alignments before communications can be established between Port A and Port B. The optical-link initiation procedure for this situation can include one or more the following steps:

1) A self-tuning process A1 is first run at Port A. The emission spectrum of the transmitter 112 is tuned by adjusting temperature to a wavelength channel that is specified in calibration data or by an external signal.

2) After the self-tuning, Port A sends one or more service request messages Sa1 to Port B. Message Sa1 can include the specific wavelength channel number that Port A is tuned at and other initiation information.

3) Once Port B receives Sa1, Port B starts a self-tuning process B1 for the transmitter 122. The self-tuning process B1 sets the maximum emission peak of transmitter 122 at the wavelength that matches the wavelength channel number that Port A is tuned at. Again, the tuning of the emission spectrum can be achieved by controlling temperature of the transmitter 122.

4) After the self-tuning process B1 is completed, the transmitter 122 at Port B sends out message Sb1 containing acknowledgement of receipt of Sa1 to Port A. The message Sb1 can also include the set-point of the current wavelength setting of the transmitter 122.

5) Once the message Sb1 is received by Port A, it starts a procedure A2 to measure the power of the optical signal from the Port B. The procedure A2 can also include fine tuning the wavelength of the transmitter 112 to better match with the wavelength channel at Port A. Port A sends a message Sa2 to Port B. The message may include AKG of the message Sb1 and a result of the power measurement (Rx-power) that indicates the accuracy of wavelength alignment of transmitter 122 at current wavelength setting.

6) The steps in 5) is repeated in fine tuning procedure B2 at Port B, a message Sb2 from Port B to Port A, a power measurement and fine tuning A3 at Port A, followed by a message Sa3 from Port A to Port B.

7) Upon the receipt of Sa3, Port B starts a process B3 that can calculate the best wavelength setting for the transmitter 122, adjust the wavelength setting accordingly, and store the wavelength setting data. Port B can end the optical-link initiation procedure by sending a message Sb3 that contains and End of Tuning (EOT) message.

In some embodiments, the optical-link initiation does not need fine tuning. The optical-link initiation process can end after the step 4.

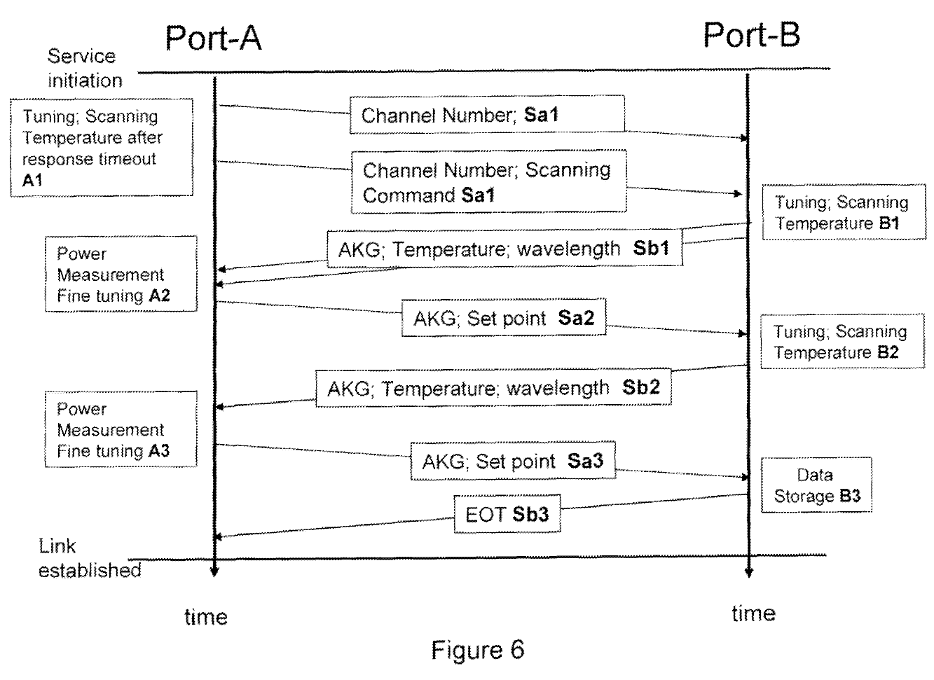

In some cases, interactive tuning is required between Ports A and B if the transmitters cannot be accurately tuned by self-tuning processes locally at Port A or B. An interactive tuning process illustrated in FIG. 6 is similar to the procedure shown in FIG. 5 except that an automatic temperature scanning process will start after the response timeout expected from Port B. The message Sa1 includes current set-point of transmitter 112 in addition to wavelength channel number and other initial information. During the scanning, one or a plurality of message Sa1 is received by receiver 126 at Port B. Then Port B starts a self-tuning process B1 for transmitter 122. One or a plurality of messages Sb1 are sent from Port B to Port A after the tuning. Message Sb1 can include an AKG of the message Sa1, the current temperature and wavelength setting for the transmitter 122 and the optimal set-point of the transmitter 112. In the procedure A2, transmitter 112 will be set to the optimal set-point. The receiver 116 at Port A also continuously measure the power of an optical signal received from the transmitter 122 at Port B in a procedure A2. The maximum power output is determined. The corresponding temperature and set wavelength are returned in message Sa2 to Port B. The above steps can be repeated until optimal and accurate wavelength and temperature settings are achieved for both transmitters 112 and 122 at Port A and Port B.

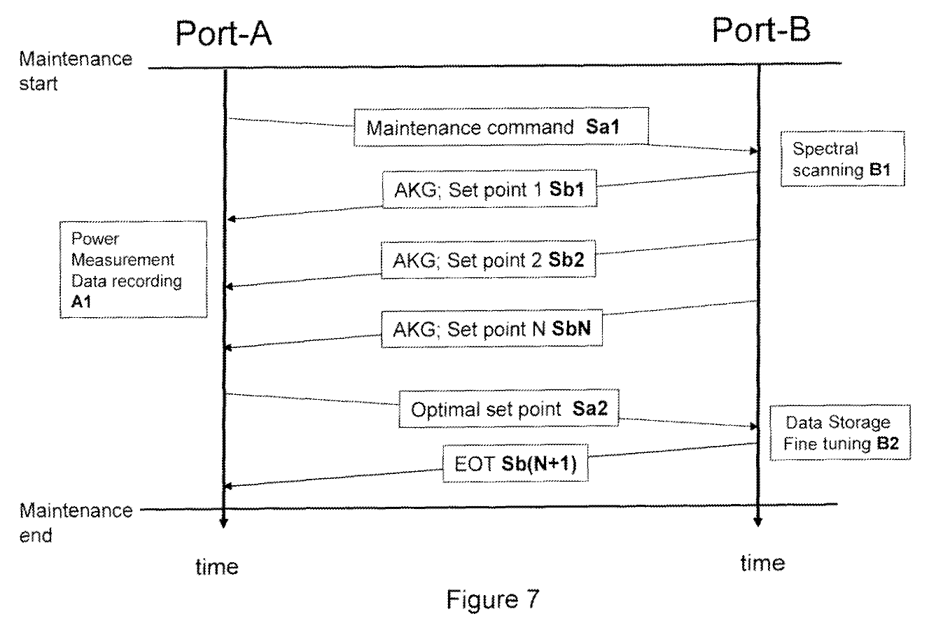

A maintenance protocol for re-aligning the wavelength channels between two ports in an optical network is shown in FIG. 7. A maintenance command Sa1 is sent from Port A to Port B. In response, Port B scans the emission spectrum of the transmitter 122 by adjusting temperature of the transmitter 122 or other control parameters. Port B reports the set points 1-N to Port A in a plurality of messages Sb1, Sb2 . . . SbN. The set points can be in the form of control temperature or set wavelength for the transmitter 112. The receiver 116 at Port A measures the power of the optical signals received from Port B. Port A records the measured optical power and determines the maximum output. The optimal set point is typically selected at the maximum power output. Port A reports the optimal set point to Port B at which the optimal set point is stored. An EOT message Sb(N+1) can be sent to Port A to confirm the end of the maintenance procedure.

It should be noted that the maintenance procedure described is applicable to either downstream or upstream directions in the optical network system 200. Port A can be either a transceiver port at an OLT 202 or an ONU 206-1 . . . or 206-N. In other words, the maintenance can be initiated either at the OLT 202 or in the field at an ONU 206-1 . . . 206-N.

It is understood that the disclosed systems and methods are compatible with other configurations of the filter, the optical transmitter, and the optical receiver. For example, the tunable light sources in the disclosed optical communication system can include various tunable lasers, temperature controlled laser, and temperature controlled super luminescent diode. The filter is not limited to the example of AWG described above. Other examples of the filter include thin-film based optical filters. The configuration of various communication devices in the disclosed system can also vary from what is described and depicted above. Wavelengths and bandwidths different from the examples described above can also be used in the broad-spectrum or the narrow-spectrum signals without deviating from the spirit of the specification. Furthermore, the wavelength tuning protocols can vary from the exemplary embodiments shown in FIG. 4 to 7.

The present specification is described above with reference to exemplary embodiments. It will be apparent to those skilled in the art that various modifications may be made and other embodiments can be used without departing from the broader scope of the present specification. Therefore, these and other variations upon the exemplary embodiments are intended to be covered by the present specification.

What is claimed is:

1. A method for remotely tuning a transmitter in an optical communication system, comprising:
receiving a control signal at a first location from a second location; and
setting a first transmitter at the first location to a first temperature in response to the control signal, wherein the emission spectrum of the first transmitter reaches a peak power at or in the vicinity of a predetermined wavelength.

2. The method of claim 1, wherein the step of setting comprises adjusting temperature of the first transmitter by a temperature controller at the first location in response to the control signal.

3. The method of claim 1, wherein the peak power has a maximum emission power in the emission spectrum of the first transmitter.

4. The method of claim 1, wherein the emission spectrum of the first transmitter reaches the maximum power at within 2 nanometer of the predetermined wavelength.

5. The method of claim 4, wherein the emission spectrum of the first transmitter reaches the maximum power at within 0.2 nanometer of the predetermined wavelength.

6. The method of claim 1, wherein the second location is an optical line terminal (OLT) or a central office, and the first location is an optical network unit (ONU).

7. The method of claim 1, wherein the distance between the first location and the second location is between 0.01 to 100 kilometers.

8. The method of claim 1, wherein the first transmitter is selected from the group of a broad spectral light source, a multi-longitudinal mode (MLM) light source, a tunable laser, and thermally tuned DFB laser.

9. The method of claim 1, wherein the optical communication system is configured to provide optical communications in a plurality of wavelength channels each characterized by a center wavelength, wherein the predetermined wavelength is associated with one of the plurality of wavelength channels.

10. The method of claim 1, wherein the predetermined wavelength is determined by an emission spectrum of a second transmitter at the second location.

11. The method of claim 1, further comprising:
emitting an optical signal by the first transmitter at the first temperature; and
receiving the optical signal by a receiver at the second location.

12. A method for remotely tuning a transmitter in an optical communication system, comprising:
receiving one or more control signals at a first location from a second location;
setting a first transmitter at the first location to a first temperature in response to the one or more control signals;
emitting a first optical signal by the first transmitter at the first temperature;
measuring a first optical power of the first optical signal at the second location;
setting the first transmitter to a second temperature in response to the one or more control signals;
emitting a second optical signal by the first transmitter at the second temperature;
measuring a second optical power of the second optical signal at the second location; and
determining temperature dependence of the emission spectrum of the first transmitter in accordance with the first optical power, the second optical power, the first temperature, and the second temperature.

13. The method of claim 12, wherein the step of setting a first transmitter comprises adjusting the temperature of the first transmitter by a temperature controller at a first location in response to the one or more control signals.

14. The method of claim 12, wherein the temperature dependence of the emission spectrum of the first transmitter comprises temperature dependence of a peak wavelength at an emission peak in the emission spectrum.

15. The method of claim 14, further comprising:
adjusting the temperature of the first transmitter in accordance with the temperature dependence of the emission spectrum of the first transmitter; and
emitting a third optical signal by the first transmitter at or in the vicinity of the peak wavelength.

16. The method of claim 14, wherein the emission peak has a maximum emission power in the emission spectrum of the first transmitter.

17. The method of claim 11, wherein the second location is an optical line terminal (OLT) or a central office, and the first location is an optical network unit (ONU).

18. The method of claim 11, wherein the distance between the first location and the second location is between 0.01 to 100 kilometers.

19. The method of claim 11, wherein the first transmitter is selected from the group of a broad spectral light source, a multi-longitudinal mode (MLM) light source, a tunable laser, and a thermally tuned DFB laser.

20. A method for initiating optical communication between an optical line terminal (OLT) and an optical network unit (ONU), comprising:
selecting a first wavelength for optical communication between the OLT and the ONU, wherein the OLT comprise a first transmitter and the ONU comprises a second transmitter;
sending a control signal from the OLT to the ONU;
setting the second transmitter to a first temperature in response to the control signal; and
emitting an upstream optical signal by the second transmitter, wherein the spectrum of the upstream optical signal reaches a peak power at or in the vicinity of a predetermined wavelength.

21. The method of claim 20, wherein the step of setting comprises adjusting temperature of the second transmitter by a temperature controller at the ONU in response to the control signal.

22. The method of claim 20, wherein the peak power has a maximum emission power in the emission spectrum of the upstream optical signal.

23. The method of claim 20, wherein the optical communication system is configured to provide optical communications in a plurality of wavelength channels each characterized by a center wavelength, wherein the predetermined wavelength is associated with one of the plurality of wavelength channels.

24. The method of claim 20, further comprising receiving the upstream optical signal by a first receiver at the OLT.

25. The method of claim 20, further comprising emitting a downstream optical signal by the first transmitter at or in the vicinity of the predetermined wavelength.

26. The method of claim 20, wherein the emission spectrum of the first transmitter has the maximum power at within 2 nanometer of the predetermined wavelength.

27. The method of claim 26, wherein the emission spectrum of the first transmitter has the maximum power at within 0.2 nanometer of the predetermined wavelength.

28. The method of claim 20, wherein the distance between the OLT and the ONU is between 0.01 to 100 kilometers.

29. The method of claim 20, wherein the first transmitter is selected from the group of a broad spectral light source, a multi-longitudinal mode (MLM) light source, a tunable laser, and a thermally tuned DFB laser.

30. A method for remotely tuning a transmitter in an optical communication system, comprising:
setting a first transmitter at a first location to a first temperature;
emitting a first optical signal by the first transmitter at the first temperature;
measuring a first optical power of the first optical signal at a second location; and
determining temperature dependence of the emission spectrum of the first transmitter in accordance with the first optical power and the first temperature.

31. The method of claim 30, further comprising
setting the first transmitter to a second temperature;
emitting a second optical signal by the first transmitter at the second temperature;
measuring a second optical power of the second optical signal at the second location; and
determining temperature dependence of the emission spectrum of the first transmitter in accordance with the first optical power, the second optical power, the first temperature, and the second temperature.

32. The method of claim 30, further comprising sending temperature dependence from the first location to the second location.

33. The method of claim 30, further comprising sending temperature dependence from the second location to the first location.

34. The method of claim 30, wherein the step of setting a first transmitter comprises adjusting the temperature of the first transmitter by a temperature controller.

35. The method of claim 30, wherein the temperature dependence of the emission spectrum of the first transmitter comprises temperature dependence of a peak wavelength at emission peak in the emission spectrum.

36. The method of claim 35, wherein the peak power has a maximum emission power in the emission spectrum of the first transmitter.

37. The method of claim 35, further comprising adjusting the temperature of the first transmitter in accordance with the temperature dependence of the emission spectrum of the first transmitter such that the peak wavelength is at or in the vicinity of a predetermined wavelength.

38. The method of claim 37, wherein the optical communication system is configured to provide optical communications in a plurality of wavelength channels each characterized by a center wavelength, wherein the predetermined wavelength is associated with one of the plurality of wavelength channels.

39. The method of claim 30, wherein the first location is an optical line terminal (OLT) or a central office, and the second location is an optical network unit (ONU).

40. The method of claim 30, wherein the first transmitter is selected from the group of a broad spectral light source, a multi-longitudinal mode (MLM) light source, a tunable laser, and a thermally tuned DFB laser.
